(19) United States
(12) Patent Application Publication
(10) Pub. No.: US 2015/0186900 A1
(43) Pub. Date: Jul. 2, 2015

(54) PRODUCT SAFETY ASSESSMENT INFORMATION MANAGEMENT SYSTEM

(71) Applicant: Ithos Global, Inc., Troy, NY (US)

(72) Inventors: Kenneth B. Bubeck, Delmar, NY (US); Carl DiClementi, Troy, NY (US); Sunil Ganesh, Green Island, NY (US)

(21) Appl. No.: 14/617,051

(22) Filed: Feb. 9, 2015

Related U.S. Application Data
(63) Continuation-in-part of application No. 13/936,282, filed on Jul. 8, 2013, now Pat. No. 8,954,415.
Application No. 13/936,282 is a division of application No. 13/029,262, filed on Feb. 17, 2011, now Pat. No. 8,484,183.

(51) Int. Cl. G06Q 30/00; G06Q 50/26

(52) U.S. Cl. CPC G06Q 30/018; G06Q 50/265

(57) ABSTRACT

Embodiments of the present invention provide a system and method for automated generation of product information files. Users provide product ingredient information and one or more jurisdictions of interest. Regulatory corpuses pertaining to the selected jurisdictions are searched, and rules pertaining to the ingredients of the product are retrieved. The product information is formatted based on a template in accordance with the guidelines of the regulatory agency of the jurisdiction. The ingredients and amounts are checked against information retrieved from the regulatory corpuses. Warnings are provided to the user if any substance is identified as prohibited or is used in an amount in excess of what the regulations of a particular jurisdiction allow.

### CROSS-REFERENCE TO RELATED APPLICATIONS

This application is a continuation-in-part of, and claims the benefit of, co-pending and co-owned U.S. patent application Ser. No. 13/936,282, filed Jul. 8, 2013, which is a division of, and claims the benefit of commonly owned U.S. patent application Ser. No. 13/029,262, filed Feb. 17, 2011, now U.S. Pat. No. 8,484,183, issued Jul. 9, 2013. The entire contents of U.S. patent application Ser. No. 13/936,282 and U.S. patent application Ser. No. 13/029,262 are incorporated by reference herein.

### FIELD OF THE INVENTION

The present invention relates generally to information management, and more particularly, to a product safety assessment information management system.

### BACKGROUND

Products for human consumption, such as food, beverages, medicines, and cosmetics products, are subjected to a plethora of regulatory requirements. Each country or jurisdiction where the products are sold may have different regulations and requirements that must be met in order to legally sell the product. Proper documentation is an important part of satisfying these requirements. A product information file is a file that details important safety information for a product, such as its ingredients and the responsible entity for the production of the product. Regulatory agencies such as the Food and Drug Administration (FDA) in the United States, and similar counterpart agencies in other countries, require that various important details be documented in a particular manner. A product information file may include numerous appendices such as safety reports, information regarding method of manufacture, testing procedures, and efficacy. In some cases, such product information files can be at least several hundred pages in length.

### SUMMARY

Embodiments of the present invention enable fast and easy data conversion from one's suppliers. The retrieved data can then be easily inserted into custom reports with a core focus on regulatory requirements.

In one aspect of the present invention, embodiments provide a method for generating a product information document for a product, comprising: obtaining a product ingredient list for the product; receiving a jurisdiction list comprising one or more jurisdictions; obtaining regulatory information for each ingredient in the product ingredient list; performing a regulation check for each jurisdiction in the jurisdiction list; generating a report which includes the product ingredient list, constituent information, and regulatory information; and generating an output status of the report.

In another aspect, embodiments of the present invention provide a system for generating a product information file for a product, comprising: a content server configured to index a plurality of regulatory corpuses, thereby forming a plurality of full-text searchable databases; a backend search module, configured to receive a search query comprising at least one search term from the client device, and send said search query to said content server; a report generation computer, wherein the report generation computer comprises computer storage medium which contains machine instructions, that when executed by the processor, performs the steps of: obtaining a product ingredient list for the product; receiving a jurisdiction list comprising one or more jurisdictions; obtaining regulatory information for each ingredient in the product ingredient list; performing a regulation check for each jurisdiction in the jurisdiction list; generating a report which includes the product ingredient list, constituent information, regulatory information; and generating an output status of the report.

In another aspect, embodiments of the present invention provide a computer program product embodied in a computer readable storage medium for implementation of a system for generating a product information file comprising machine instructions for: obtaining a product ingredient list for the product; receiving a jurisdiction list comprising one or more jurisdictions; obtaining regulatory information for each ingredient in the product ingredient list; performing a regulation check for each jurisdiction in the jurisdiction list; generating a report which includes the product ingredient list, constituent information, regulatory information; and generating an output status of the report.

### BRIEF DESCRIPTION OF THE DRAWINGS

The accompanying drawings, which are incorporated in and constitute a part of this specification, illustrate several embodiments of the present teachings, and, together with the description, serve to explain the principles of the present teachings.

FIG. 1 is a block diagram of a system in accordance with embodiments of the present invention.

FIG. 2 shows details of a server used in the embodiment of FIG. 1.

FIG. 3 is a flowchart indicating process steps for document generation in accordance with embodiments of the present invention.

FIG. 4 shows an exemplary product information entry user interface.

FIG. 5 shows an exemplary product information constituents user interface.

FIG. 6 shows an exemplary appendix selection entry user interface.

FIG. 7 shows an exemplary product information file outline.

FIG. 8 shows exemplary output status information.

FIG. 9 is a flowchart indicating additional process steps for document generation in accordance with embodiments of the present invention.

FIG. 10 shows details of a report generation computer used in the embodiment of FIG. 1.

### DETAILED DESCRIPTION

Embodiments of the present invention provide a system and method for automated generation of product information files. Users provide product ingredient information and one or more jurisdictions of interest. In embodiments, regulatory corpuses pertaining to the selected jurisdictions are searched, and rules pertaining to the ingredients of the product are retrieved. Additional supporting data such as test results and safety information may also be retrieved. The product information is formatted based on a template in accordance with the guidelines of the regulatory agency of the jurisdiction. The ingredients and amounts are checked against information retrieved from the regulatory corpuses. Warnings are provided to the user if any substance is identified as prohibited or is used in an amount in excess of what the regulations of a particular jurisdiction allow. Thus, the onerous task of preparing large product information files (PIFs) for multiple countries/jurisdictions is greatly simplified. In addition, users may be provided with warnings for ingredients that may be restricted or prohibited in certain jurisdictions. This early warning gives producers an opportunity to reformulate if possible, in order to streamline approval processes in as many jurisdictions as possible. This leads to reduced time and cost for getting such products to market.

The terminology used herein is for the purpose of describing particular embodiments only and is not intended to be limiting of this disclosure. For example, as used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Reference throughout this specification to “one embodiment,” “an embodiment,” “embodiments,” “exemplary embodiments,” “some embodiments”, or similar language means that a particular feature, structure, or characteristic described in connection with the embodiment is included in at least one embodiment of the present invention. Thus, appearances of the phrases “in one embodiment,” “in an embodiment,” “in embodiments”, “in some embodiments”, and similar language throughout this specification may, but do not necessarily, all refer to the same embodiment.

Moreover, the described features, structures, or characteristics of the invention may be combined in any suitable manner in one or more embodiments. Features, structures, or characteristics of one embodiment can be mixed and matched with features, structures, or characteristics of another embodiment. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

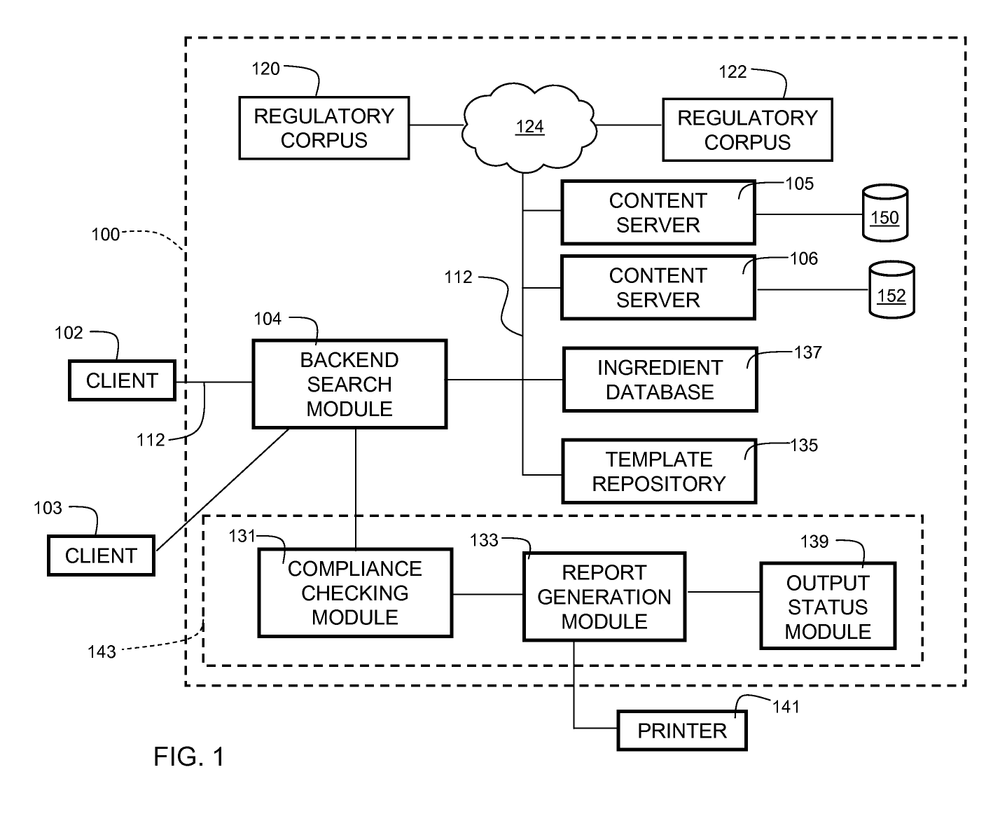

FIG. 1 is a block diagram 100 of a system in accordance with embodiments of the present invention. System 100 interacts with one or more client devices (examples shown as 102 and 103), which may be a personal computer or other suitable platform for running a client device. In one embodiment, the client device 102 is a computer that executes a browser to render a so-called “web-based” user interface. The client device communicates with a backend search module 104. The backend search module 104 receives search requests from client device 102 and in turn, sends the search request to a plurality of content servers (indicated as 105 and 106). While two content servers (105, 106) are shown in FIG. 1, embodiments of the present invention may have more or fewer content servers.

The content servers 105 and 106 each comprise one or more databases, for example, 150 and 152, respectively. Each content server performs a search on the data in the databases using the search query that is received from the client device 102. The results of the search are then sent back to the backend search module 104, which then sends the results to the client device 102. The content servers 105 and 106, backend search module 104, and client device 102 are devices comprising a processor, and computer storage medium which contains machine instructions, that when executed by the processor, perform methods disclosed herein. In some embodiments, the computer storage medium may be non-transitory computer storage medium. Non-limiting examples of computer storage include static RAM, ROM, and flash memory. These devices are interconnected via communications network 112. In one embodiment, communications network 112 may include the Internet 124. Hence, embodiments of the present invention may support multiple simultaneous users from multiple client devices. The content servers 105 and 106 build internal, searchable databases based on existing regulatory corpuses 120 and 122. These databases may be referred to as “ingredient databases” or each as an “ingredient database”. In practice, there may be many such regulatory corpuses. In one embodiment, the regulatory corpuses may include regulations available on the Internet from the US Food and Drug Administration, and counterpart agencies internationally.

System 100 further comprises an ingredient database 137. The ingredient database 137 comprises many known substances, and may be indexed by IUPAC (International Union of Pure and Applied Chemistry) name, other names (synonyms), brand names, chemical formulas, or other suitable data. Additionally, the ingredient database 137 may further be indexed by numerical or alphanumeric identifiers, including, but not limited to, CAS number (Chemical Abstracts Service number), and/or PubChem number. The data from the regulatory corpuses may be searched to find maximum levels/amounts/concentrations of each ingredient as well as to generate a list of prohibited substances. This information may then also be stored in the ingredients database 137. In embodiments, the ingredients database 137 may be implemented as an SQL (structured query language database). There may be defined a plurality of fields, including, but not limited to, ingredient name, ingredient synonym, jurisdiction, and allowable range for each jurisdiction. In embodiments, the ingredients database includes a range comprising a maximum and a minimum allowed value for each jurisdiction. In embodiments, a maximum range of zero indicates a prohibited substance, and a maximum range of -1 indicates that no rules apply for that substance in a given jurisdiction.

A portal (e.g., web-based service) may be used to allow ingredient suppliers to submit requested data and documents that contain key elements to assist in the creation of formatted compliance reports that go to governmental organizations. Some or all of this data may be entered in ingredients database 137.In embodiments, data may be uploaded via an Excel, CSV format, or other suitable file.

System 100 further may comprise a template repository 135. The template repository may contain one or more word processor template files (e.g., a *.dot file for Microsoft Word, or a *.doc file with pre-defined formatting) that describe the formatting for the product information file. Although much of the information is required by multiple jurisdictions, the formatting and order of sections may differ. For example, the United States and European Union may require different formatting for product information files. Thus, the template repository may contain template files for multiple jurisdictions, including, but not limited to, The United States, Canada, Mexico, Brazil, The European Union, Japan, Australia, and The Philippines, to name a few non-limiting examples.

Each template may contain: static text that is aligned with the desired document output structure, data field markers that are used to locate the targeted data that is collected and organized in the data structure, attachment field markers that are used to locate the required documents (PDF (portable document file), Word, Excel documents) provided by suppliers, and highlighted text that marks, for easy location, where the data and documents were inserted in the final document output. These features allow users to quickly adapt to changing format requirements without additional development.

System 100 further comprises a report generation computer 143. The report generation computer 143 may comprise one or more software modules, including, but not limited to, a compliance checking module 131, a report generation module 133, and an output status module 139. The compliance checking module performs checks of substances and amounts based on information in one or more regulatory corpuses. The report generation module assembles a product information file based on information provided by a user, examples of which may include, but is not limited to, an ingredient list, responsible party information, manufacturing data, safety information, and test results. In embodiments, more or fewer types of information may be included. The report generation module 133 assembles a document using the input information. Some information may be missing or may require user input. The product information file may be generated using colored fields to indicate data that the user is required to either confirm, or enter manually. An output status module 139 may be used to generate a list of errors and/or warnings pertaining to the product information file. The errors/warnings may include page numbers where manual entry or user confirmation is needed. Additionally, the errors/warnings may include page numbers where information that normally is entered automatically is missing, thus requiring user attention. System 100 may optionally print to a printer 141. Printer 141 may be a high-speed laser printer that is used for producing hard copies of the product information file.

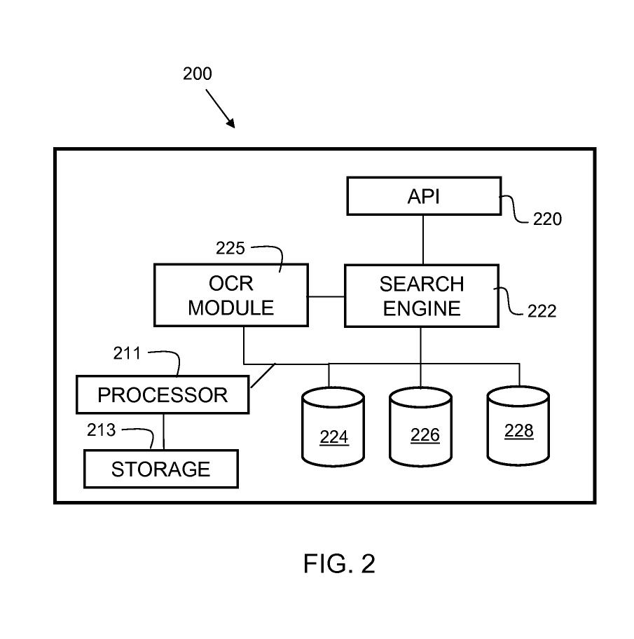

FIG. 2 shows details of a content server 200 used in the embodiment of FIG. 1. Architecturally, content server 200 is similar to content servers 105 and 106 of FIG. 1. Content server 200 comprises a processor 211, and computer storage 213 which contains machine instructions, that when executed by the processor, perform methods disclosed herein. Content server 200 comprises at least one repository, for example, repositories 224, 226, 228. Each repository is a full text searchable repository, which is searched by search engine 222. In one embodiment, search engine 222 is comprised of a fully inverted indexing system, such as Livelink Discovery Server by Open Text Corporation. Application Programming Interface (API) module 220 interfaces with the backend search module 104 of FIG.1. It receives search queries from the backend search module 104 and, upon completion of execution of the search queries, communicates search results to the backend search module 104 for dissemination to client devices (see 102, 103 of FIG. 1). In one embodiment, API module 220 is implemented via PHP (Personal Home Page Tools). In another embodiment, the API module 220 is implemented via dot Net framework.

Optionally, an embodiment may further comprise Optical Character Recognition (OCR) module 225. In some cases, relevant documents from Internet sources may not be in a text-searchable form, and may comprise graphics files such as TIFF files or PDF files with no searchable text. In this case, OCR module 225 performs an OCR process to convert information to text, such that it may be stored in one or more of the repositories (224, 226, 228).

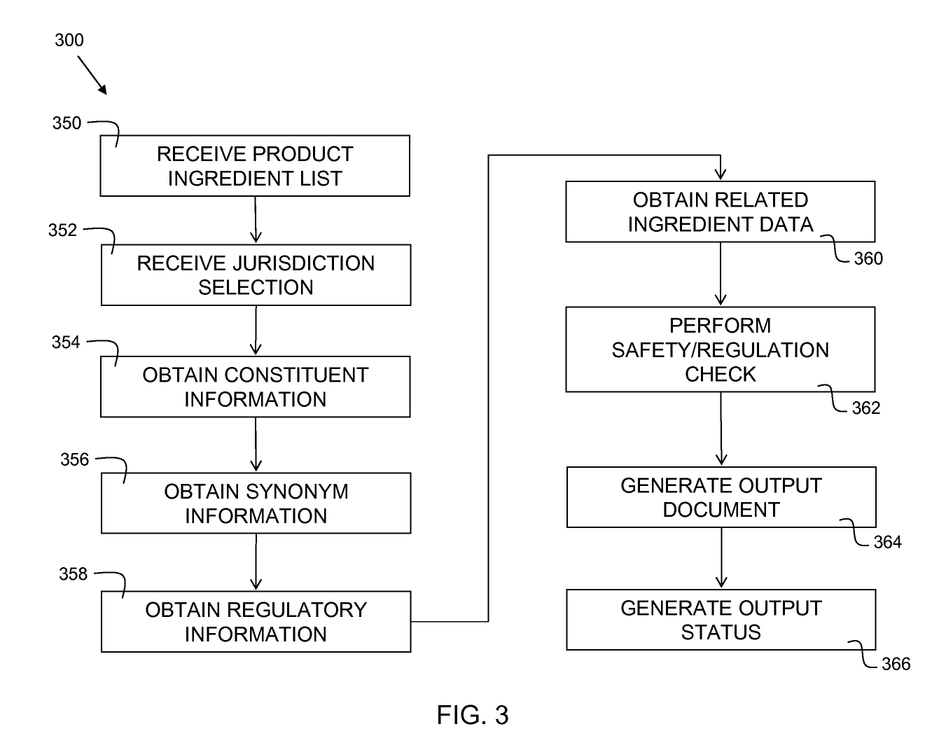

FIG. 3 is a flowchart 300 indicating process steps for document generation in accordance with embodiments of the present invention. In process step 350, an ingredient list is received. This may include a list of ingredients and amounts for a particular product (for example, a specific shampoo or other cosmetic product). The user may upload a product ingredient list in a spreadsheet format, CSV format, text format, HTML format, XML format, or other suitable format. In process step 352, a jurisdiction selection is received. This includes one or more jurisdictions for which a product information file is desired (e.g., US and Canada). The selected jurisdictions may then be inserted into a jurisdiction list within the report generation computer. For each jurisdiction in the jurisdiction list, a product information file is to be generated. In process step 354, optionally, constituent information is obtained. In some embodiments, the user may supply an ingredient list that contains ingredients which are further broken into constituents. For example, an ingredient of “Fragrance 204D7” may be further decomposed into separate ingredients that make up Fragrance 204D7. In embodiments, this is done automatically if the constituent information for Fragrance 204D7 is present in the ingredient database (137 of FIG. 1). In process step 356, synonym information is obtained. Various substances may be known by more than one name. For example, the substance p-Anisicacid may also be known as 4-methoxybenzoic acid or draconic acid. Therefore, when a user uploads an ingredient list that contains p-Anisic acid, the synonyms of 4-methoxybenzoic acid and draconic acid are retrieved from the ingredient database. In process step 358, regulatory information is obtained. This may comprise searching of regulatory corpuses at that time, or alternatively, the regulatory corpuses may be searched a priori, and the information stored in the ingredient database. In embodiments, the regulatory information includes maximum and minimum allowable amounts of each ingredient for one or more jurisdictions. Each ingredient is checked against the regulatory corpuses corresponding to the jurisdiction selection of process step 352. When searching regulatory corpuses to look for any regulations pertaining to p-Anisic acid, a similar search is also performed for the synonyms, in case any one of the regulatory corpuses use one of the synonyms instead of the ingredient name as provided by the user. In embodiments, the regulations from the regulatory corpuses are retrieved a priori and loaded into the ingredient database. In such embodiments, the regulatory corpus searching may comprise performing SQL queries on the ingredient database instead of searching the regulatory corpuses directly.

In process step 360, ingredient related data is obtained. The ingredient data may include PDF formatted documents provided by ingredient suppliers. In embodiments, the system may retrieve the latest version of such documents from supplier websites. The ingredient data may include, without limitation, test results, safety information, manufacturing information, and/or responsible party information. Safety information may include, but is not limited to, approved dosage/amount levels for the ingredient, shelf life information, and information pertaining to the safe storage of the ingredient (e.g., temperature, humidity levels, and the like). In process step 362, a safety and/or regulation check is performed. A regulation check may include comparing each ingredient provided by the user to each regulatory corpus for the jurisdiction(s) that the user selected. The regulatory corpuses may reside in government databases. Prohibited substances are identified, along with the jurisdiction(s) in which they are prohibited. Additionally, substances that are outside of a legal range are identified. Furthermore, an additional safety check may be performed using a Margin of Safety (MoS) table. The MoS table may be a user-defined table accessible to the report generation computer where additional limits for ingredients may be entered. In this way, the user has the capability to define safety requirements that can trigger a warning, even if none of the selected regulatory corpuses contain data that results in issuance of a warning. Thus, if a particular ingredient is present or exceeds a predetermined amount, a warning can be triggered, even if that ingredient is not specifically prohibited in any of the selected jurisdiction(s).Unlike regulatory content, safety content is not specified by the different jurisdictions where clients operate (or wish to). Instead, safety content can be found in various formats depending on the source being used, and may not yet be available (in whole or in parts) for all the substances companies use in their manufacturing.

In process step 364, an output document (or report) is generated, which is a product information file. Throughout this application, “output document” and “product information file” are used interchangeably. In embodiments, the output document is in a word processor format (e.g., a Microsoft Word document, or other word processing document). In some embodiments, the output document may be a PDF document with fillable fields. The document is formatted based on a template corresponding to the jurisdiction for which it is generated. Thus, for a United States product information file, a US template is used, and for a Canadian product information file, a Canadian template is used, etc. In process step 366, an output status is generated. The output status can convey information to the user about the document that is generated. The output status may include warnings for substances that are prohibited in certain jurisdictions and/or exceed legal limits. Furthermore, alerts for missing information, and/or information that the user is to manually enter, may also be provided.

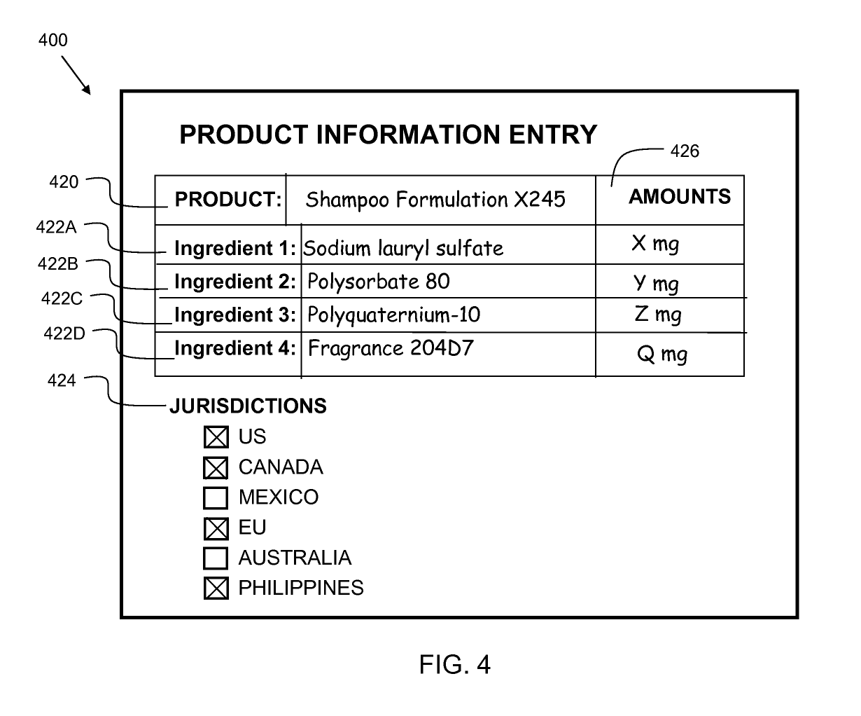

FIG. 4 shows an exemplary product information entry user interface 400. The user interface 400 comprises a product name field 420, and one or more product ingredient fields (422A-422D). For each product ingredient field, a corresponding amount is entered in column 426. The amount may be entered in any appropriate units for that substance (e.g., by weight, volume, or other suitable measure). A jurisdictions selection field 424 allows the user to select one or more jurisdictions for which a product information file is desired. As shown in FIG. 4, the user has selected the US, EU, Canada, and The Philippines, but has not selected Mexico or Australia. Thus, the regulatory corpuses for the US, EU, Canada, and The Philippines will be searched during the process to create the product information files.

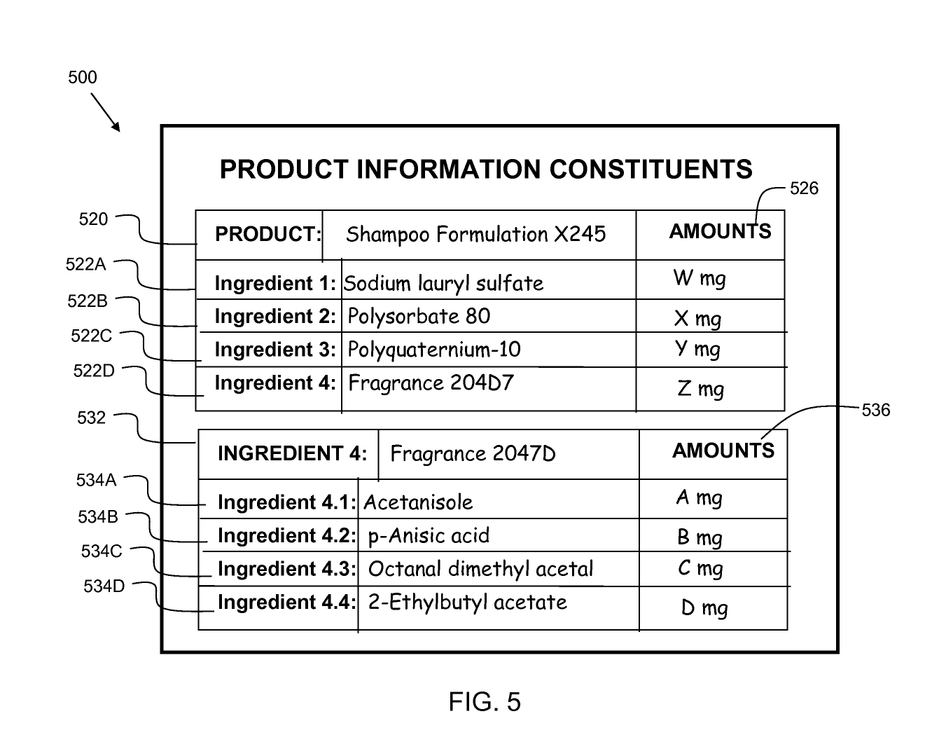

FIG. 5 shows an exemplary product information constituents user interface 500. The user interface 500 comprises a product name field 520, and one or more product ingredient fields (522A-522D). For each product ingredient field, a corresponding amount is entered in column 526. As stated previously, in some embodiments, the user may supply an ingredient list that contains ingredients which are further broken into constituents. For example, an ingredient of “Fragrance 204D7” may be further decomposed into separate ingredients that make up fragrance 204D7. As shown in FIG. 5, ingredient 522D is “Fragrance 204D7.” The system searches the ingredient database to find the constituents that makeup Fragrance 204D7, and may display them in a table 532 as shown in FIG. 5. In this example, the four constituents (534A-534D) are used to make Fragrance 204D7. The amounts of each constituent may be derived from the amount of the sub-product (e.g., the Fragrance 204D7 in this example). The amounts may be displayed in column 536 of table 532. The retrieved constituents may then also be expanded by applying a synonym expansion for each of the constituents. The constituents may then also be searched within the regulatory corpuses corresponding to the selected jurisdictions. In this way, a thorough documentation of the product, as well as the “sub-products” that go into the product, is achieved.

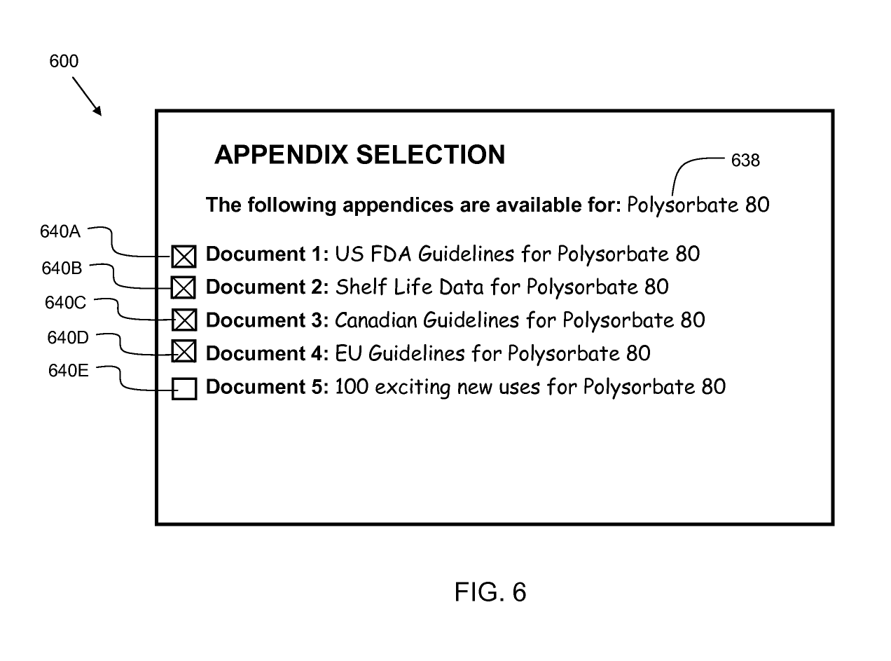

FIG. 6 shows an exemplary appendix selection entry user interface 600. As described previously for process step 360 in FIG. 3, related ingredient data for one or more of the ingredients may be automatically retrieved from local and/or remote databases and/or repositories. The related ingredient data may include PDF files, and/or image files, such as TIFF files. In some cases, the PDF files may be non-text PDF files. For each ingredient 638, the user is presented with an option to select which additional file(s) are to be included as appendixes in the product information file. The attachments may be binary files. As shown in the example of FIG. 6, there are five files available (640A-640E), and files 640A-640D are selected for inclusion into the product information file, and file 640E is unselected, and hence is not to be included in the product information file. In some embodiments, this may be done once and applied to each product information file. In other embodiments, the appendix selection may be performed for each product information file jurisdiction. In such a case, for example, the EU data may be omitted from Canadian product information files.

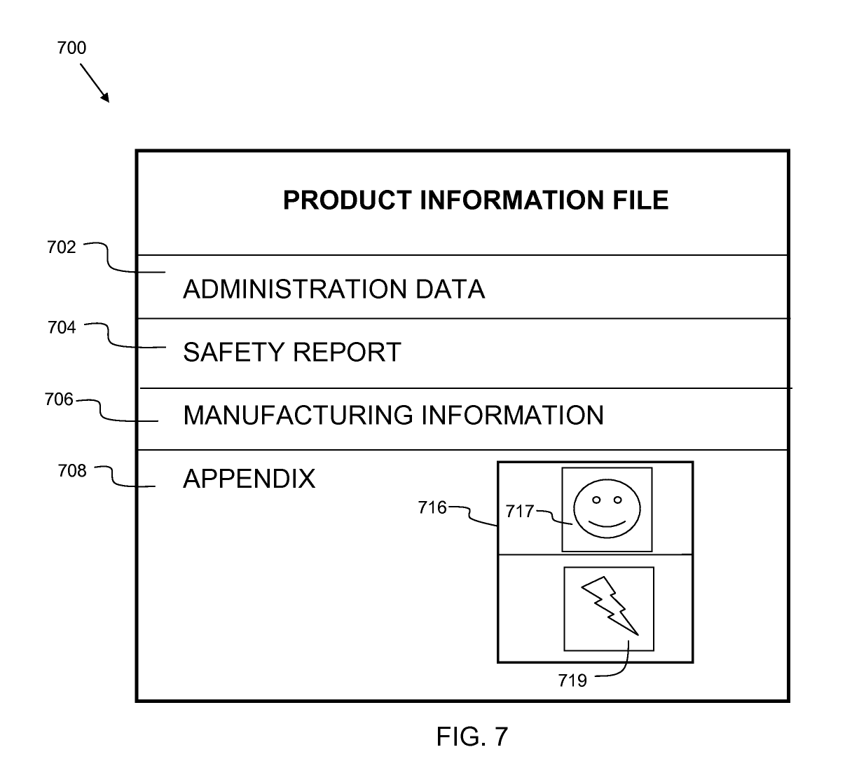

FIG. 7 shows an exemplary outline of a generated output document (product information file) 700. The product information file 700 comprises administration data 702. Administration data 702 may include, but is not limited to, product manufacturer company name, product manufacturer company address, product manufacturer responsible person name, and/or product manufacturer responsible person title. The product information file 700 further comprises safety report 704. Safety report 704 may include, but is not limited to, a qualitative ingredient list, a quantitative ingredient list, raw materials information, and/or allergen information. The product information file 700 further comprises manufacturing information 706. Manufacturing information 706 may include, but is not limited to, GMP (Good Manufacturing Practice) certification information, and/or manufacturing procedures. The product information file 700 further comprises appendix data 708. Appendix data 708 may include a plurality of images (717, 719). The images may be pages from a PDF file that are converted into a graphics format such as a TIFF or PNG file and inserted into a table 716 that is part of the product information file 700. By inserting each image of a supporting document as an entry within a table, it serves to organize each supporting document within its own table, providing improved formatting options. Note that while images are shown formatted within a table in the appendix, similar tables with images therein may also be present in the other sections of the product information file, such as sections 702, 704, and/or 706.

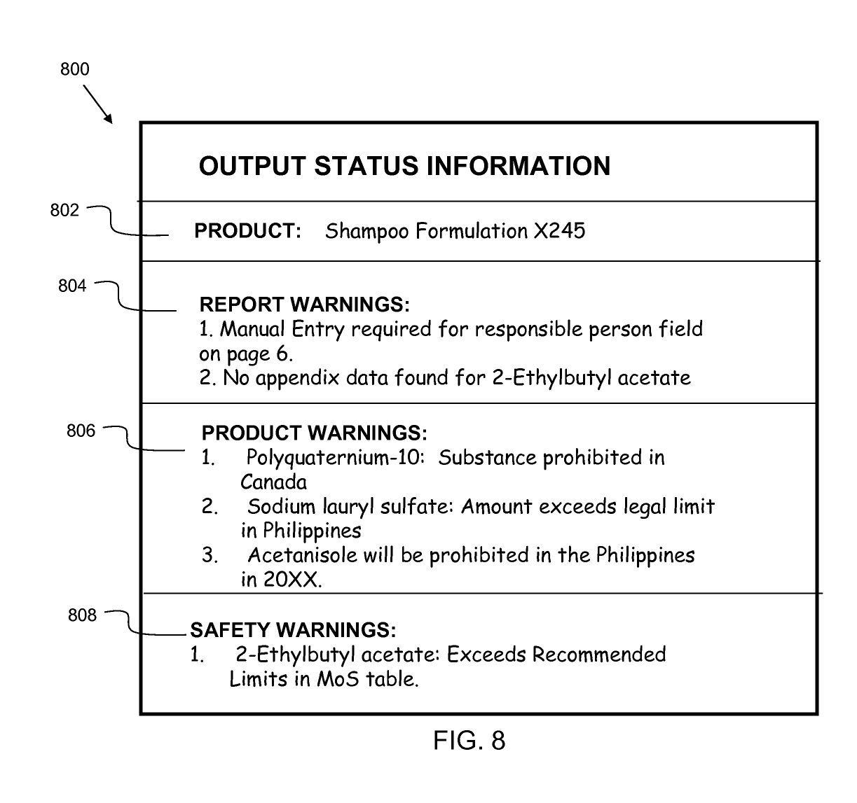

FIG. 8 shows exemplary output status information 800. The status information 800 provides output status for the output document (product information file), and may include a product name section 802, which lists the name of the product. The status information 800 may include a report warnings section 804, which lists warnings pertaining to report formatting, such as missing or incomplete data, and/or data requiring manual entry. The page numbers and other identifiers to indicate the location of the problem may be provided. The status information 800 may include a product warnings section 806, which lists warnings pertaining to prohibited substances based on searching of the regulatory corpuses. The warnings may include indication of prohibited substances, and/or warnings of substances where the amounts exceed the amounts set forth in the regulatory corpuses. The product warnings section may, in some embodiments, include warnings about regulations that have yet to go into effect, such as warning number 3 in section 806, for example. The status information 800 may include a safety warnings section 808, which lists warnings pertaining to prohibited substances based on a Margin of Safety (MoS) table.

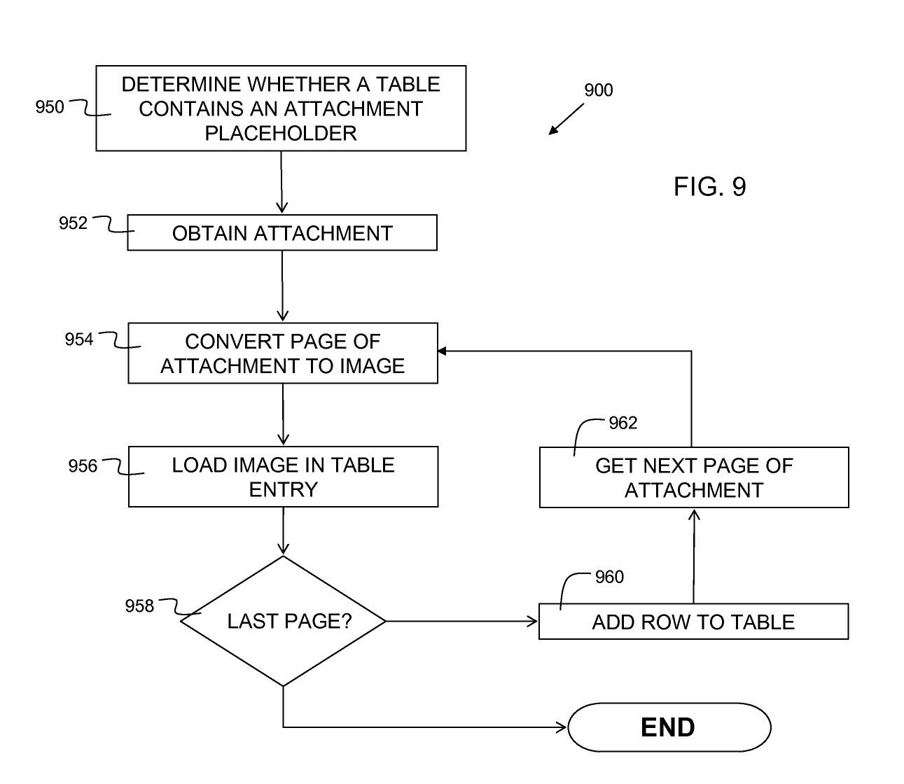

FIG. 9 is a flowchart 900 indicating additional process steps for document generation in accordance with embodiments of the present invention. In particular, flowchart 900 describes steps for inserting images into a table of a word processing document. In process step 950, a determination is made as to whether a table contains an attachment placeholder. The table may utilize a predefined string such as “#attachment” to indicate that images are to be placed within each row of a 1×X table, where X corresponds to the number of pages of the source attachment. In process step 952, an attachment is obtained, as per user selections described for FIG. 6. In process step 954, a page (starting with the first page) of the attachment (typically a PDF file) is converted into an image file, such as a BMP, PNG, or TIFF file. In embodiments, the image may be scaled to fit with a page size of 8.5×11, A4 paper, or other suitable size. In process step 956, the image is loaded into an entry of the table. In process step 958, a check is made to see if the last page of the attachment has been processed. If not, the process proceeds to process step 960, and a row is dynamically added to the table. In process step 962, the next page of the attachment is obtained, and the process then continues back to step 954. This cycle repeats until the last page of the attachment is processed.

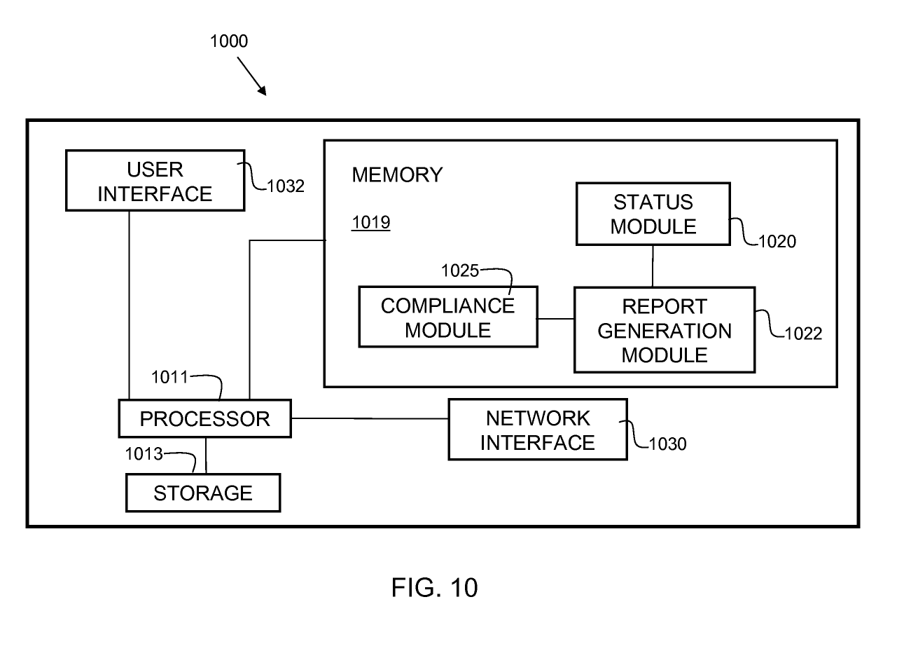

FIG. 10 shows details of a report generation computer 1000 used in the embodiment of FIG. 1. A processor 1011 is configured to execute instructions stored in memory 1019. In some embodiments, memory may be non-transitory memory. Processor 1011 may also be coupled to storage 1013, which may include a mass storage device such as magnetic hard disk, solid state hard disk, or other suitable storage mechanism. Processer 1011 is also coupled to a network interface 1030, which facilitates communication over a communications network. Network interface 1030 may include a wired Ethernet interface, wireless Ethernet interface, or other suitable communications interface. Processor 1011 may also be coupled to user interface 1032. User interface 1032 may include, but is not limited to, a display, a keyboard, a mouse, a touch screen, and/or a microphone configured to accept voice commands.

Within memory 1019 are machine instructions. The machine instructions may be organized into modules. A compliance module 1025 contains instructions, which when executed by the processor 1011, perform checks on a submitted list of ingredients. The checks are based on limits and restrictions contained within one or more regulatory corpuses, and/or a Margin of Safety table. A report generation module 1022 contains instructions, which when executed by the processor 1011, compiles and concatenates various information into a report. This may follow a predefined template (e.g., a *.dot file in Microsoft Word). The output format for the report may be in a word processor format, rich text format, and/or a PDF format. A status module 1020 contains instructions, which when executed by the processor 1011, provides results of the document generation to the user. This informs the user whether the document generation was successful, and what, if any, areas of the document require user attention to confirm or add information. The areas that require attention may be color-coded by the report generation module 1022, making it easy and efficient for a user to find and correct/confirm them. Thus, with embodiments of the present invention, it is now possible to use both structured and unstructured information to generate documents that are hundreds of pages long in a fraction of the time it took previously, and also provide improved compliance checking The compliance checks find potential problems earlier in the product development cycle, giving more time for correction, and saving costs associated with product changes.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. Non-limiting examples of a computer readable storage medium may include static RAM, ROM, flash memory, optical storage such as a compact disc or DVD, and magnetic storage such as a hard disk.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While shown and described herein as a product safety assessment information management system, it is understood that the invention further provides various other embodiments. For example, in one embodiment, the invention provides a computer-readable/useable medium that includes computer program code to enable a computer infrastructure to provide product safety assessment information management functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium may comprise program code embodied on one or more portable structure storage articles of manufacture (e.g., a compact disc, a magnetic disk, a tape, etc.), on one or more data storage portions of a computing device (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide device protection functionality. In this case, the service provider can create, maintain, support, etc., a computer infrastructure, such as the system shown in FIG. 1 that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for a device protection. In this case, a computer infrastructure, such as the system shown in FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as the system shown in FIG. 1 from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

While the invention has been particularly shown and described in conjunction with exemplary embodiments, it will be appreciated that variations and modifications will occur to those skilled in the art. For example, although the illustrative embodiments are described herein as a series of acts or events, it will be appreciated that the present invention is not limited by the illustrated ordering of such acts or events unless specifically stated. Some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the formation and/or processing of structures illustrated and described herein as well as in association with other structures not illustrated. Moreover, in particular regard to the various functions performed by the above described components (assemblies, devices, circuits, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A method for generating a product information document for a product, comprising:
obtaining a product ingredient list for the product;
receiving a jurisdiction list comprising one or more jurisdictions;
obtaining regulatory information for each ingredient in the product ingredient list;
performing a regulation check for each jurisdiction in the jurisdiction list;
generating a product information file which includes the product ingredient list, constituent information, and regulatory information; and
generating an output status of the product information file.

2. The method of claim 1, further comprising obtaining constituent information for at least one ingredient in the product ingredient list.

3. The method of claim 1, further comprising locating synonyms for each ingredient in the product ingredient list.

4. The method of claim 1, further comprising performing a safety check using a margin-of-safety table.

5. The method of claim 1, wherein generating an output status of the product information file comprises generating a warning if at least one ingredient of the product ingredient list is prohibited in at least one jurisdiction of the jurisdiction list.

6. The method of claim 1, wherein generating an output status of the output document comprises generating a warning if at least one ingredient of the product ingredient list has an amount that exceeds a maximum level in a regulation of at least one jurisdiction of the jurisdiction list.

7. The method of claim 4, wherein generating an output status of the output document comprises generating a warning if at least one ingredient of the product ingredient list has an amount that exceeds a maximum level in a margin of safety table.

8. The method of claim 1, further comprising obtaining related ingredient data, wherein obtaining related ingredient data comprises retrieving one or more portable document format (PDF) files pertaining to at least one ingredient of the product ingredient list, wherein each PDF file comprises one or more pages.

9. The method of claim 8, wherein generating an output document further comprises:
inserting a table in a word processing document file;
converting each page of the one or more PDF files into an image; and
inserting each image into an entry within the table.

10. A system for generating a product information file for a product, comprising:
a content server configured to index a plurality of regulatory corpuses, thereby forming a plurality of full-text searchable databases;
a backend search module, configured to receive a search query comprising at least one search term from the client device, and send said search query to said content server;
a report generation computer, wherein the report generation computer comprises computer storage medium which contains machine instructions, that when executed by the processor, performs the steps of:
obtaining a product ingredient list for the product;
receiving a jurisdiction list comprising one or more jurisdictions;
obtaining regulatory information for each ingredient in the product ingredient list;
performing a regulation check for each jurisdiction in the jurisdiction list;
generating a report which includes the product ingredient list, constituent information, regulatory information; and
generating an output status of the report.

11. The system of claim 10, wherein the computer storage contains machine instructions, that when executed by the processor, perform the steps of obtaining constituent information for at least one ingredient in the product ingredient list.

12. The system of claim 10, wherein the computer storage contains machine instructions, that when executed by the processor, perform the steps of generating a warning if at least one ingredient of the product ingredient list is prohibited in at least one jurisdiction of the jurisdiction list.

13. The system of claim 10, wherein the computer storage contains machine instructions, that when executed by the processor, perform the steps of generating a warning if at least one ingredient of the product ingredient list has an amount that exceeds a maximum level in a regulation of at least one jurisdiction of the jurisdiction list.

14. The system of claim 10, wherein the computer storage contains machine instructions, that when executed by the processor, performs the steps of :
inserting a table in a word processing document file;
converting each page of the one or more PDF files into an image; and
inserting each image into an entry within the table.

15. A computer program product embodied in a computer readable storage medium for implementation of a system for generating a product information file comprising machine instructions for:
obtaining a product ingredient list for the product;
receiving a jurisdiction list comprising one or more jurisdictions;
obtaining regulatory information for each ingredient in the product ingredient list;
performing a regulation check for each jurisdiction in the jurisdiction list;
generating the product information file which includes the product ingredient list, constituent information, regulatory information; and
generating an output status of the product information file.

16. The computer program product of claim 15, further comprising machine instructions for:
inserting a table in a word processing document file;
converting each page of the one or more PDF files into an image; and
inserting each image into an entry within the table.

17. The computer program product of claim 15, further comprising machine instructions for generating a warning if at least one ingredient of the product ingredient list is prohibited in at least one jurisdiction of the jurisdiction list.

18. The computer program product of claim 15, further comprising machine instructions for generating a warning if at least one ingredient of the product ingredient list has an amount that exceeds a maximum level in a regulation of at least one jurisdiction of the jurisdiction list.

19. The computer program product of claim 15, further comprising machine instructions for performing a safety check using a margin-of-safety table.

20. The computer program product of claim 15, further comprising machine instructions for generating a warning if at least one ingredient of the product ingredient list has an amount that exceeds a maximum level in a margin of safety table.
